(19) United States
(12) Patent Application Publication
(10) Pub. No.: US 2019/0087351 A1
(43) Pub. Date: Mar. 21, 2019

(54) TRANSACTION DISPATCHER FOR MEMORY MANAGEMENT UNIT

(71) Applicant: QUALCOMM Incorporated, San Diego, CA (US)

(72) Inventors: Sadayan Ghows Ghani Sadayan Ebramsah Mo ABDUL, Austin, TX (US); Piyush PATEL, Cary, NC (US); Michael TROMBLEY, Cary, NC (US); Rakesh ANIGUNDI, San Diego, CA (US); Jason NORMAN, Cary, NC (US); Aaron SEYFRIED, Raleigh, NC (US)

(21) Appl. No.: 16/136,116

(22) Filed: Sep. 19, 2018

Related U.S. Application Data
(60) Provisional application No. 62/561,181, filed on Sep. 20, 2017.

(51) Int. Cl. G06F 12/1027; G06F 12/1009; G06F 12/1081; G06F 12/02; G06F 9/46

(52) U.S. Cl. CPC G06F 12/1027; G06F 12/1009; G06F 12/1081; G06F 2212/7201; G06F 9/467; G06F 2212/68; G06F 12/0246

(57) ABSTRACT

According to various aspects, a memory management unit (MMU) having multiple parallel translation machines may collect transactions in an incoming transaction stream and select appropriate transactions to dispatch to the parallel translation machines. For example, the MMU may include a dispatcher that can identify different transactions that belong to the same address set (e.g., have the same address translation) and dispatch one transaction from each transaction set to an individual translation machine. As such, the dispatcher may be used to ensure that multiple parallel translation machines do not perform identical memory translations, as other transactions that share the same address translation may obtain the translation results from a translation lookaside buffer.

### CROSS-REFERENCE TO RELATED APPLICATIONS

The present application claims the benefit of U.S. Provisional Application No. 62/561,181, entitled “TRANSACTION DISPATCHER FOR MEMORY MANAGEMENT UNIT,” filed Sep. 20, 2017, the contents of which are hereby expressly incorporated by reference in their entirety.

### TECHNICAL FIELD

The various aspects and embodiments described herein relate to computer memory systems, and in particular, to increasing utilization associated with translation hardware used in a memory management unit (MMU).

### BACKGROUND

Virtual memory is a memory management technique provided by most modern computing systems. Using virtual memory, a central processing unit (CPU) or a peripheral device of the computing system may access a memory buffer using a virtual memory address mapped to a physical memory address within a physical memory space. In this manner, the CPU or peripheral device may be able to address a larger physical address space than would otherwise be possible, and/or may utilize a contiguous view of a memory buffer that is, in fact, physically discontiguous across the physical memory space.

Virtual memory is conventionally implemented through the use of a memory management unit (MMU) for translation of virtual memory addresses to physical memory addresses. The MMU may be integrated into the CPU of the computing system (a CPU MMU), or may comprise a separate circuit providing memory management functions for peripheral devices (a system MMU, or SMMU). In conventional operation, the MMU receives memory access requests from “upstream” devices, such as direct memory access (DMA) agents, video accelerators, and/or display engines, as non-limiting examples. For each memory access request, the MMU translates the virtual memory addresses included in the memory access request to a physical memory address, and the memory access request is then processed using the translated physical memory address.

Because an MMU may be required to translate the same virtual memory address repeatedly within a short time interval, performance of the MMU and the computing system overall may be improved by caching address translation data within the MMU. In this regard, the MMU may include a structure known as a translation cache (also referred to as a translation lookaside buffer, or TLB). The translation cache provides translation cache entries in which previously generated virtual-to-physical memory address translation mappings may be stored for later access. If the MMU subsequently receives a request to translate a virtual memory address stored in the translation cache, the MMU may retrieve the corresponding physical memory address from the translation cache rather than retranslating the virtual memory address.

However, the performance benefits achieved through use of the translation cache may be lost in scenarios in which the MMU processes transactions in an incoming transaction stream in order of arrival. For example, the MMU may have multiple independent parallel translation machines that can each process one transaction at a time. However, the independent parallel translation machines could end up performing multiple identical translations based on the incoming translation request stream (e.g., where multiple requests are in the same memory region). This leads to a waste of hardware resources, specifically the translation machines and bus bandwidth.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a memory management unit (MMU) having multiple parallel translation machines may collect transactions in an incoming transaction stream and select appropriate transactions to dispatch to the parallel translation machines. For example, the MMU may include a dispatcher that can identify different transactions that belong to the same address set (e.g., have the same address translation) and dispatch one transaction from each transaction set to an individual translation machine. As such, the dispatcher may be used to ensure that multiple parallel translation machines do not perform identical memory translations, as other transactions that share the same address translation may obtain the translation results from a translation lookaside buffer. In this manner, utilization associated with memory translation hardware (e.g., the parallel translation machines) may be increased due to fewer duplicate memory accesses, which may also allow the data bus to serve other requests and thus increase bandwidth in the memory translation system.

According to various aspects, a method for dispatching memory transactions may comprise receiving a transaction stream comprising multiple memory transactions at a dispatcher coupled to a memory translation unit configured to perform multiple memory address translations in parallel, identifying, among the multiple memory transactions in the transaction stream, one or more transaction sets that each include one or more memory transactions that share a memory address translation, and dispatching, to the memory translation unit, one memory transaction for translation per transaction set such that the memory translation unit is configured to perform one memory address translation per transaction set.

According to various aspects, an apparatus for processing memory transactions may comprise a memory translation unit configured to perform multiple memory address translations in parallel and a dispatcher coupled to the memory translation unit, wherein the dispatcher may receive a transaction stream comprising multiple memory transactions, identify, among the multiple memory transactions in the transaction stream, one or more transaction sets that each include one or more memory transactions that share a memory address translation, and dispatch, to the memory translation unit, one memory transaction for translation per transaction set such that the memory translation unit performs one memory address translation per transaction set.

According to various aspects, an apparatus may comprise means for receiving a transaction stream comprising multiple memory transactions, means for identifying, among the multiple memory transactions in the transaction stream, one or more transaction sets, wherein the one or more transaction sets each include one or more memory transactions that share a memory address translation, and means for dispatching, to a memory translation unit configured to perform multiple memory address translations in parallel, one memory transaction for translation per transaction set such that the memory translation unit is configured to perform one memory address translation per transaction set.

According to various aspects, a non-transitory computer-readable storage medium may have computer-executable instructions recorded thereon, wherein the computer-executable instructions may be configured to cause one or more processors to receive a transaction stream comprising multiple memory transactions, identify, among the multiple memory transactions in the transaction stream, one or more transaction sets, wherein the one or more transaction sets each include one or more memory transactions that share a memory address translation, and dispatch, to a memory translation unit configured to perform multiple memory address translations in parallel, one memory transaction for translation per transaction set such that the memory translation unit is configured to perform one memory address translation per transaction set.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary computing system including communications flows from upstream devices to a memory management unit (MMU) providing address translation services, according to various aspects.

FIG. 2 illustrates an exemplary MMU that may provide address translation services using multiple parallel translation machines, according to various aspects.

FIG. 3 illustrates an exemplary MMU that may include a dispatcher to increase utilization associated with multiple parallel translation machines and increase bandwidth in the memory translation system, according to various aspects.

FIG. 4 illustrates an exemplary method that may be performed in the dispatcher shown in FIG. 3, according to various aspects.

FIG. 5 illustrates exemplary timelines showing the performance benefits that may be realized from using the dispatcher shown in FIG. 3 to increase utilization associated with multiple parallel translation machines and increase bandwidth in the memory translation system, according to various aspects.

FIG. 6 illustrates an exemplary electronic device that may be configured in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

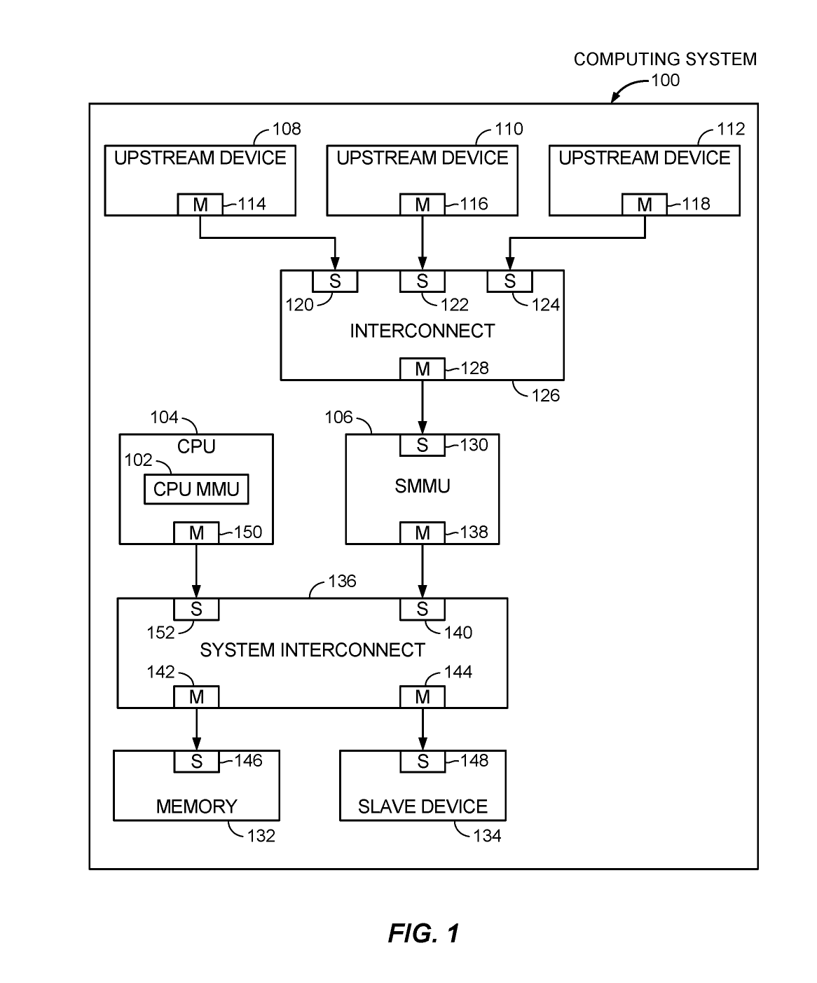

Before discussing exemplary apparatuses and methods for increasing hardware utilization, increasing throughput, and decreasing bus bandwidth requirements in a memory management unit (MMU) having multiple parallel translation machines as disclosed herein, a conventional computing system providing virtual-to-physical memory address translation is described. In this regard, FIG. 1 is a block diagram illustrating an exemplary computing system 100 in which a central processing unit (CPU) MMU 102 provides address translation services for a CPU 104, and a system MMU (SMMU) 106 provides address translation services for upstream devices 108, 110, and 112. It is to be understood that the computing system 100 and the elements thereof may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

As seen in FIG. 1, the computing system 100 includes the upstream devices 108, 110, and 112 having master ports (M) 114, 116, and 118, respectively, that are connected to corresponding slave ports (S) 120, 122, and 124 of an interconnect 126. In some aspects, each of the upstream devices 108, 110, and 112 may comprise a peripheral device such as a direct memory access (DMA) agent, a video accelerator, and/or a display engine, as non-limiting examples. The interconnect 126 may receive memory access requests (not shown) from the upstream devices 108, 110, and 112, and may transfer the memory access requests from a master port (M) 128 to a slave port (S) 130 of the SMMU 106. After receiving each memory access request, the SMMU 106 may perform virtual-to-physical memory address translation, and, based on the address translation, may access a memory 132 and/or a slave device 134 via a system interconnect 136. As shown in FIG. 1, a master port (M) 138 of the SMMU 106 communicates with a slave port (S) 140 of the system interconnect 136. The system interconnect 136, in turn, communicates via master ports (M) 142 and 144 with slave ports (S) 146 and 148, respectively, of the memory 132 and the slave device 134. In some aspects, the memory 132 and/or the slave device 134 may comprise a system memory, system registers, and/or memory-mapped input/output (110) devices, as non-limiting examples. It is to be understood that, while the SMMU 106 serves the upstream devices 108, 110, and 112, some aspects may provide that the SMMU 106 may serve more or fewer upstream devices than illustrated in FIG. 1.

As noted above, the computing system 100 also includes the CPU 104 having integrated therein the CPU MMU 102. The CPU MMU 102 may provide address translation services for CPU memory access requests (not shown) of the CPU MMU 102 in much the same manner that the SMMU 106 provides address translation services to the upstream devices 108, 110, and 112. After performing virtual-to-physical memory address translation of a CPU memory access request, the CPU MMU 102 may access the memory 132 and/or the slave device 134 via the system interconnect 136. In particular, a master port (M) 150 of the CPU 104 communicates with a slave port (S) 152 of the system interconnect 136. The system interconnect 136 then communicates via the master ports (M) 142 and 144 with the slave ports (S) 146 and 148, respectively, of the memory 132 and the slave device 134.

To improve performance, an MMU, such as the CPU MMU 102 and/or the SMMU 106, may provide a translation cache (not shown) for storing previously generated virtual-to-physical memory address translation mappings. However, in the case of an MMU that has multiple parallel translation machines, the performance benefits achieved through use of the translation cache (also referred to as a translation lookaside buffer, or TLB) may be reduced in scenarios in which the MMU processes transactions in an incoming transaction stream in order of arrival.

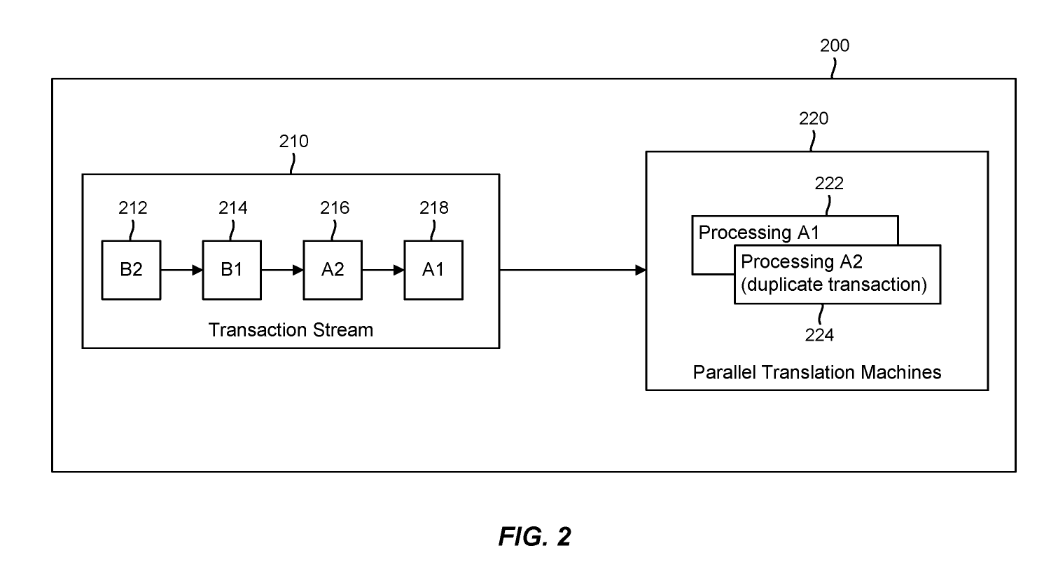

In this regard, FIG. 2 is provided to illustrate the above-mentioned problems in context with an exemplary MMU 200 that may provide address translation services using memory translation hardware 220 that includes multiple parallel translation machines 222, 224. Although the example MMU 200 shown in FIG. 2 includes two parallel translation machines 222, 224, those skilled in the art will appreciate that the present disclosure contemplates that the memory translation hardware 220 may include more translation machines than the two shown in FIG. 2. In the example MMU 200 shown in FIG. 2, the memory translation hardware 220 may end up performing identical memory translations based on the transactions in an incoming transaction stream 210 when the transactions in the incoming transaction stream 210 are processed in order of arrival. For example, in FIG. 2, the incoming transaction stream 210 may include a first transaction (A1) 218 and a second transaction (A2) 216 that belong to the same address region (e.g., a 4K memory region). Furthermore, the incoming transaction stream 210 may include a third transaction (B1) 214 and a fourth transaction (B2) 212 that belong to the same address region, which is different from the address region associated with the first transaction 218 and the second transaction 216. In general, only the first transaction 218 and the third transaction 214 would need to be translated, as the second transaction 216 in the same address region as the first transaction 218 should be able to utilize the translation results from the first transaction 218 and the same reasoning may apply to the third transaction 214 and the fourth transaction 212.

However, because the MMU 200 shown in FIG. 2 translates addresses for the transactions 212-218 in the incoming transaction stream 210 in order of arrival, the transactions within the same memory address region(s) would all perform identical translations, utilizing all parallel hardware to perform duplicate walks and consequently increase data bus traffic. This problem applies to any memory translation unit that performs more than one (1) translation at a time, such as the memory translation hardware 220 shown in FIG. 2. For example, in FIG. 2, the parallel translation machines 222, 224 each have the ability to process one (1) transaction at a time, wherein N parallel machines processing one (1) transaction each result in a total of N parallel transactions that can be processed in the memory translation hardware 220. As such, based on an order of arrival scheme as shown in FIG. 2, the first transaction 218 is sent to the first translation machine 222 and the next transaction 216 is sent to the second translation machine 224, whereby the parallel translation machines 222, 224 are essentially performing identical address translations at substantially the same time.

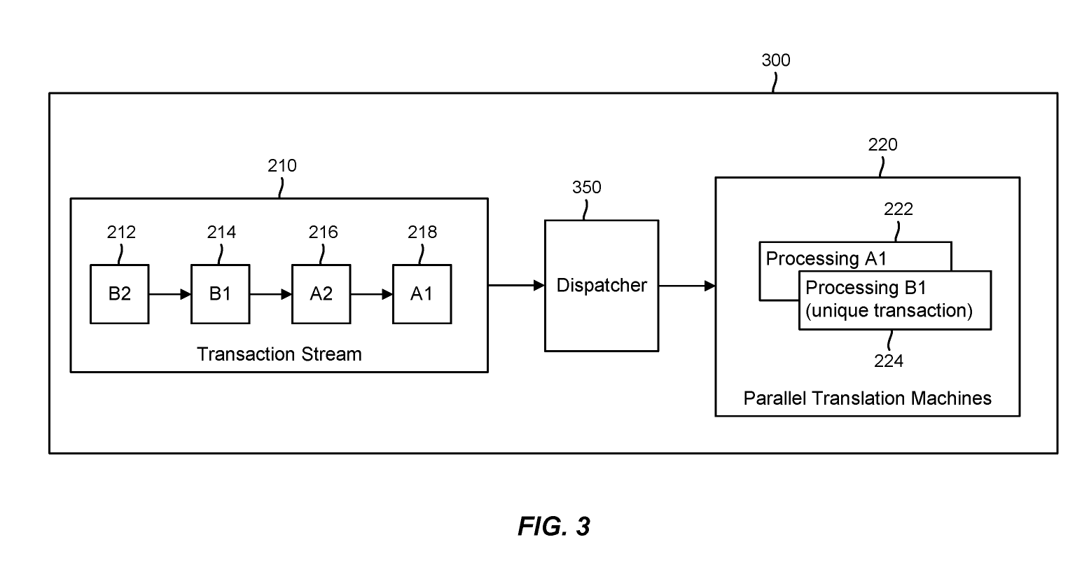

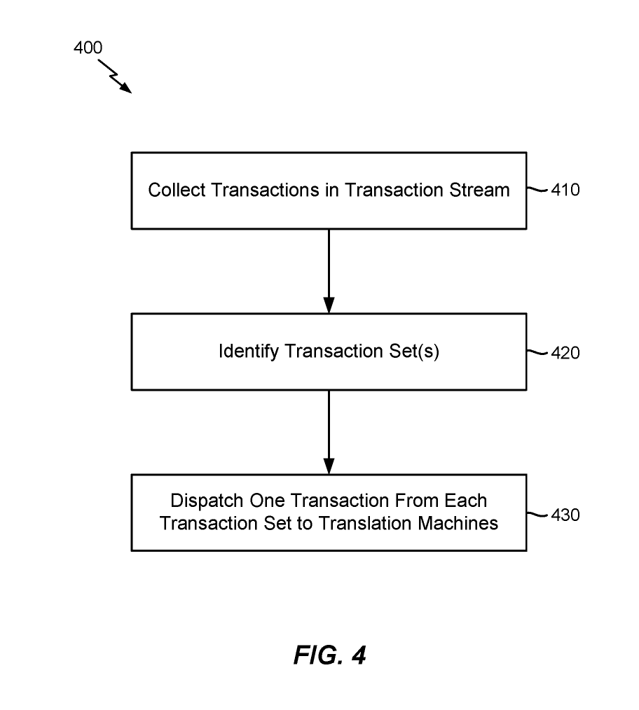

Accordingly, to avoid the wasted hardware resources and bus bandwidth from having the parallel translation machines 222, 224 perform identical translations, FIG. 3 illustrates an exemplary MMU 300 that introduces a dispatcher 350, which may perform a method 400 as illustrated in FIG. 4 to increase utilization associated with the memory translation hardware 220, increase throughput, decrease bus bandwidth requirements, and allow the data bus to serve other requests. For example, with reference to block 410 in FIG. 4, the dispatcher 350 may collect the transactions in the incoming transaction stream 210 and select appropriate transactions to be sent to the translation machines 222, 224. In this regard, at block 420, the dispatcher 350 may determine that the first transaction 218 and the second transaction 216 belong to the same address set and similarly determine that the third transaction 214 and the fourth transaction 212 belong to the same address set. In one example, the dispatcher 350 may identify the transaction set(s) based on the transactions being within the same memory region or otherwise having similar transaction attributes. In general, the dispatcher 350 may employ or otherwise consider any suitable transaction parameter that could result in a different address translation when identifying the transaction set(s) used to group multiple transactions that share or are substantially likely to share the same address translation.

In various embodiments, with reference to block 430 in FIG. 4, the dispatcher 350 may then dispatch one (1) transaction per transaction set to the available translation machines 222, 224, thereby increasing the number of unique transactions that are processed at a given time and increasing throughput while decreasing bus bandwidth requirements. For example, in the example where transactions 216, 218 are grouped in one transaction set while transactions 214, 212 are grouped in another transaction set due to being in the same memory region, the dispatcher 350 may send the first transaction 218 to the first translation machine 222 and the second transaction 216 may simply obtain the translation results associated with the first transaction 218 from the translation cache or TLB. In a similar respect, the dispatcher 350 may send the third transaction 214 to the second translation machine 224 and the fourth transaction 212 that is not sent to the memory translation hardware 220 may obtain the translation results from the third transaction 214 from the translation cache or TLB.

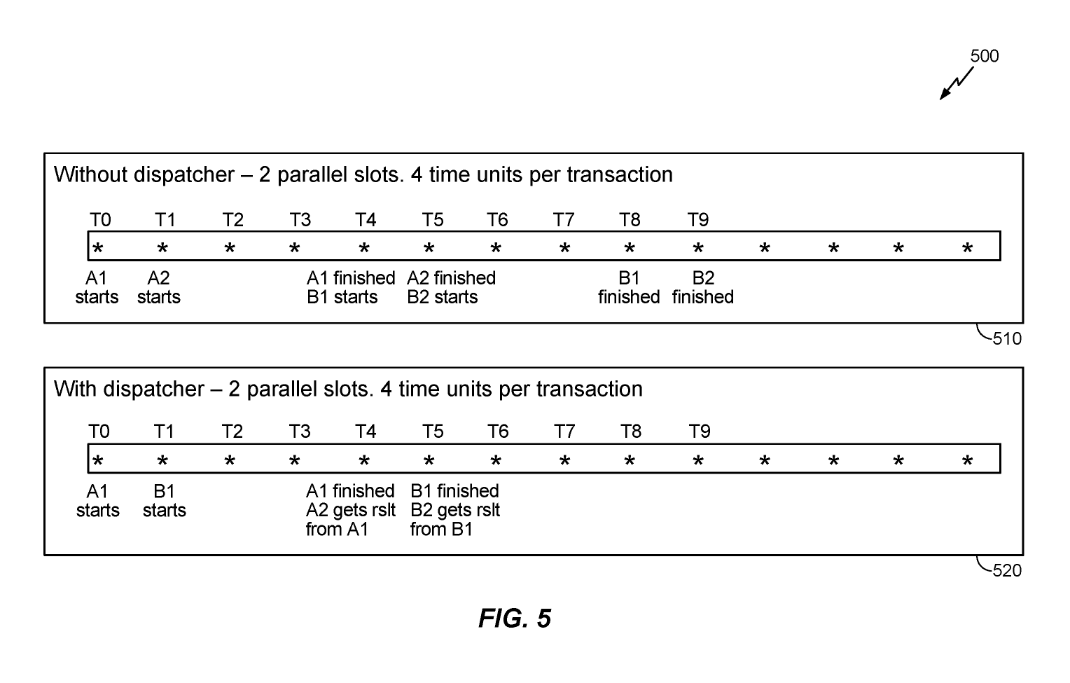

According to various aspects, FIG. 5 illustrates the performance benefits that may be realized from using the dispatcher 350 shown in FIG. 3 in conjunction with the method 400 shown in FIG. 4 to increase utilization associated with multiple parallel translation machines and increase bandwidth in the memory translation system. For example, in FIG. 5, a first timeline 510 shows the number of time units needed to perform address translations in the MMU 200 shown in FIG. 2, which assumes two (2) parallel slots and four (4) time units per transaction. In the first timeline 510, the first translation machine 222 starts to process the first transaction 218 at time T0 and finishes translating the first transaction 218 at time T4. Furthermore, the second translation machine 224 starts to process the second transaction 216 at time T1 and finishes the translation at time T5. As such, from time T1 until time T4, both translation machines 222, 224 are performing identical address translations, and the other transactions 214, 212 do not complete until time T8 and T9, respectively. In contrast, a second timeline 520 is provided to show the performance benefits associated with the dispatcher 350 described above. In particular, rather than starting to process the second transaction 216 in the transaction stream 210 at time T1, the dispatcher 350 may skip the second transaction 216 because the translation will be the same as the first transaction 218, meaning that the second transaction 216 can obtain the translation results from the translation cache or TLB at time T4 when the first transaction 218 has finished. Accordingly, at time T1, the dispatcher 350 may send for translation the third transaction 214 that belongs to a different transaction set relative to the transaction 218 already sent for translation. Accordingly, the third transaction 214 and all other transaction(s) in the transaction stream 210 that share the same translation as the third transaction 214 may obtain the appropriate translation results at time T5 when the memory translation hardware 220 has completed the dispatched third transaction 214.

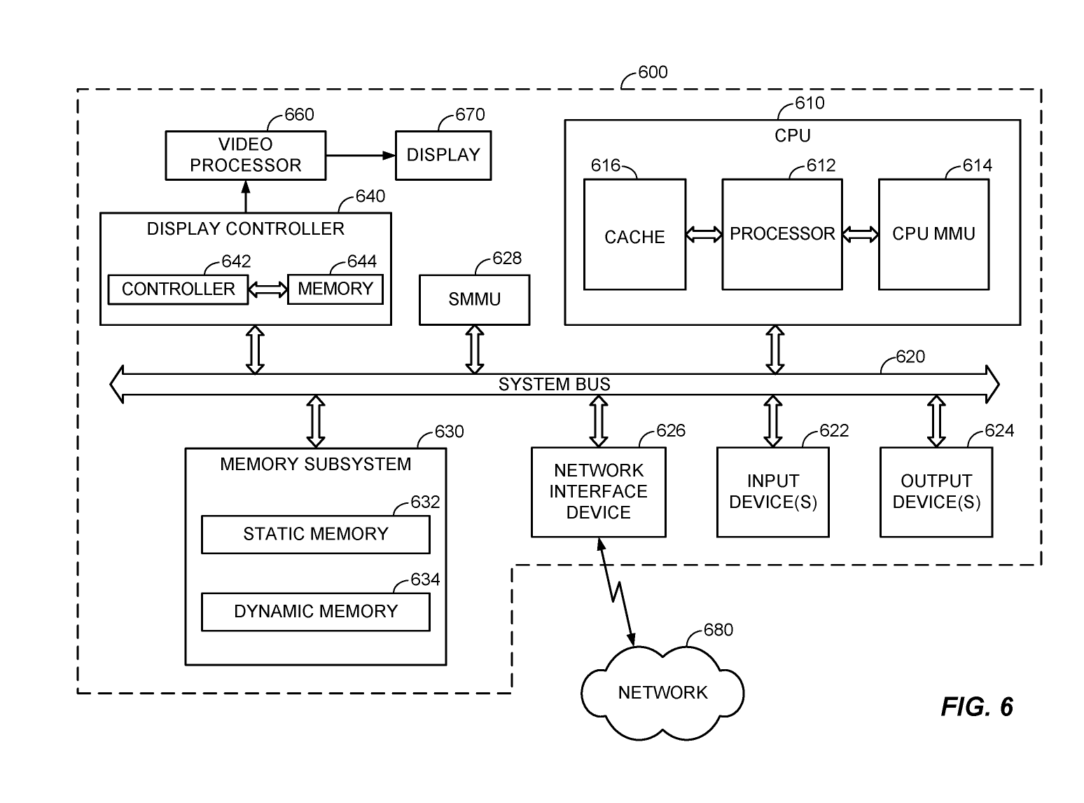

According to various aspects, FIG. 6 illustrates an exemplary electronic device 600 that may employ the MMU 300 as illustrated in FIG. 3, which may be configured to perform the method 400 shown in FIG. 4 and described in further detail above. For example, the electronic device 600 shown in FIG. 6 may be a processor-based system that includes at least one central processing unit (CPU) 610 that includes a processor 612 and a cache 616 for rapid access to temporarily stored data. The CPU 610 may further include a CPU MMU 614 for providing address translation services for CPU memory access requests. According to various embodiments, the CPU 610 may be coupled to a system bus 620, which may intercouple various other devices included in the electronic device 600, including an SMMU 628, wherein the CPU MMU 614 and/or the SMMU 628 may be configured in accordance with the MMU 300 shown in FIG. 3. As will be apparent to those skilled in the art, the CPU 610 may exchange address, control, and data information over the system bus 620 to communicate with the other devices included in the electronic device 600, which can include suitable devices. For example, as illustrated in FIG. 6, the devices included in the electronic device 600 can include a memory subsystem 630 that can include static memory 632 and/or dynamic memory 634, one or more input devices 622, one or more output devices 624, a network interface device 626, and a display controller 640. In various embodiments, the input devices 622 can include any suitable input device type, including but not limited to input keys, switches, voice processors, etc. The output devices 624 can similarly include any suitable output device type, including but not limited to audio, video, other visual indicators, etc. The network interface device 626 can be any device configured to allow exchange of data to and from a network 680, which may comprise any suitable network type, including but not limited to a wired or wireless network, private or public network, a local area network (LAN), a wide local area network (WLAN), and the Internet. The network interface device 626 can support any type of communication protocol desired. The CPU 610 can access the memory subsystem 630 over the system bus 620.

According to various embodiments, the CPU 610 can also access the display controller 640 over the system bus 620 to control information sent to a display 670. The display controller 640 can include a memory controller 642 and memory 644 to store data to be sent to the display 670 in response to communications with the CPU 610. The display controller 640 sends information to the display 670 to be displayed via a video processor 660, which processes the information to be displayed into a format suitable for the display 670. The display 670 can include any suitable display type, including but not limited to a cathode ray tube (CRT), a liquid crystal display (LCD), a plasma display, an LED display, a touchscreen display, a virtual-reality headset, and/or any other suitable display.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for dispatching memory transactions, comprising:
receiving a transaction stream comprising multiple memory transactions at a dispatcher coupled to a memory translation unit configured to perform multiple memory address translations in parallel;
identifying, among the multiple memory transactions in the transaction stream, one or more transaction sets, wherein the one or more transaction sets each include one or more memory transactions that share a memory address translation; and
dispatching, to the memory translation unit, one memory transaction for translation per transaction set such that the memory translation unit is configured to perform one memory address translation per transaction set.

2. The method recited in claim 1, wherein the one or more transaction sets include at least one transaction set in which one or more memory transactions that are not sent to the memory translation unit for translation are configured to use the memory address translation associated with the one memory transaction dispatched for translation.

3. The method recited in claim 2, wherein a translation lookaside buffer is configured to make the memory address translation associated with the dispatched memory transaction available to the one or more memory transactions that are not sent to the memory translation unit for translation.

4. The method recited in claim 3, wherein the memory address translation is a virtual-to-physical memory address translation.

5. The method recited in claim 1, wherein the memory translation unit includes multiple translation machines configured to perform the multiple memory address translations in parallel.

6. The method recited in claim 5, wherein the multiple translation machines are each configured to perform one memory address translation at a time.

7. The method recited in claim 1, wherein identifying the one or more transaction sets comprises:
determining that the multiple memory transactions in the transaction stream include at least a first memory transaction and a second memory transaction configured to access the same memory address region; and
grouping the first memory transaction with the second memory transaction.

8. The method recited in claim 1, wherein the dispatcher and the memory translation unit are integrated into a memory management unit.

9. An apparatus for processing memory transactions, comprising:
a memory translation unit configured to perform multiple memory address translations in parallel; and
a dispatcher coupled to the memory translation unit, wherein the dispatcher is configured to receive a transaction stream comprising multiple memory transactions, identify, among the multiple memory transactions in the transaction stream, one or more transaction sets that each include one or more memory transactions that share a memory address translation, and dispatch, to the memory translation unit, one memory transaction for translation per transaction set such that the memory translation unit is configured to perform one memory address translation per transaction set.

10. The apparatus recited in claim 9, wherein the one or more transaction sets include at least one transaction set in which one or more memory transactions that are not sent to the memory translation unit for translation are configured to use the memory address translation associated with the one memory transaction dispatched for translation.

11. The apparatus recited in claim 10, wherein a translation lookaside buffer is configured to make the memory address translation associated with the dispatched memory transaction available to the one or more memory transactions that are not sent to the memory translation unit for translation.

12. The apparatus recited in claim 11, wherein the memory address translation is a virtual-to-physical memory address translation.

13. The apparatus recited in claim 9, wherein the memory translation unit includes multiple translation machines configured to perform the multiple memory address translations in parallel.

14. The apparatus recited in claim 13, wherein the multiple translation machines are each configured to perform one memory address translation at a time.

15. The apparatus recited in claim 9, wherein the dispatcher is further configured to:
determine that the multiple memory transactions in the transaction stream include at least a first memory transaction and a second memory transaction configured to access the same memory address region; and
group the first memory transaction with the second memory transaction.

16. The apparatus recited in claim 9, wherein the dispatcher and the memory translation unit are integrated into a memory management unit.

17. An apparatus, comprising:
means for receiving a transaction stream comprising multiple memory transactions;
means for identifying, among the multiple memory transactions in the transaction stream, one or more transaction sets, wherein the one or more transaction sets each include one or more memory transactions that share a memory address translation; and
means for dispatching, to a memory translation unit configured to perform multiple memory address translations in parallel, one memory transaction for translation per transaction set such that the memory translation unit is configured to perform one memory address translation per transaction set.

18. The apparatus recited in claim 17, wherein the one or more transaction sets include at least one transaction set in which one or more memory transactions that are not sent to the memory translation unit for translation are configured to use the memory address translation associated with the one memory transaction dispatched for translation.

19. The apparatus recited in claim 18, wherein a translation lookaside buffer is configured to make the memory address translation associated with the dispatched memory transaction available to the one or more memory transactions that are not sent to the memory translation unit for translation.

20. The apparatus recited in claim 19, wherein the memory address translation is a virtual-to-physical memory address translation.

21. The apparatus recited in claim 17, wherein the memory translation unit includes multiple translation machines configured to perform the multiple memory address translations in parallel.

22. The apparatus recited in claim 21, wherein the multiple translation machines are each configured to perform one memory address translation at a time.

23. The apparatus recited in claim 17, wherein the means for identifying comprises:
means for determining that the multiple memory transactions in the transaction stream include at least a first memory transaction and a second memory transaction configured to access the same memory address region; and
means for grouping the first memory transaction with the second memory transaction.

24. A non-transitory computer-readable storage medium having computer-executable instructions recorded thereon, the computer-executable instructions configured to cause one or more processors to:
receive a transaction stream comprising multiple memory transactions;
identify, among the multiple memory transactions in the transaction stream, one or more transaction sets, wherein the one or more transaction sets each include one or more memory transactions that share a memory address translation; and
dispatch, to a memory translation unit configured to perform multiple memory address translations in parallel, one memory transaction for translation per transaction set such that the memory translation unit is configured to perform one memory address translation per transaction set.

25. The non-transitory computer-readable storage medium recited in claim 24, wherein the one or more transaction sets include at least one transaction set in which one or more memory transactions that are not sent to the memory translation unit for translation are configured to use the memory address translation associated with the one memory transaction dispatched for translation.

26. The non-transitory computer-readable storage medium recited in claim 25, wherein a translation lookaside buffer is configured to make the memory address translation associated with the dispatched memory transaction available to the one or more memory transactions that are not sent to the memory translation unit for translation.

27. The non-transitory computer-readable storage medium recited in claim 26, wherein the memory address translation is a virtual-to-physical memory address translation.

28. The non-transitory computer-readable storage medium recited in claim 24, wherein the memory translation unit includes multiple translation machines configured to perform the multiple memory address translations in parallel.

29. The non-transitory computer-readable storage medium recited in claim 28, wherein the multiple translation machines are each configured to perform one memory address translation at a time.

30. The non-transitory computer-readable storage medium recited in claim 24, wherein the computer-executable instructions are further configured to cause one or more processors to:
determine that the multiple memory transactions in the transaction stream include at least a first memory transaction and a second memory transaction configured to access the same memory address region; and
group the first memory transaction with the second memory transaction.
